(19) United States
(12) Patent Application Publication
(10) Pub. No.: US 2011/0235145 A1
(43) Pub. Date: Sep. 29, 2011

(54) OPTICAL COMPONENT FOR REFRACTING LIGHT RAYS PASSING THROUGH THE OPTICAL COMPONENT

(75) Inventors: Gerald Futterer, Dresden (DE); Stephan Reichelt, Dresden (DE)

(73) Assignee: SeeReal Technologies S.A., Munsbach (LU)

(21) Appl. No.: 13/133,667

(22) PCT Filed: Dec. 8, 2009
(86) PCT No.: PCT/EP2009/066563

§ 371 Date: Jun. 9, 2011

(30) Foreign Application Priority Data
Dec. 9, 2008 (DE) 10 2008 054 438.8

(51) Int. Cl. G02B 26/08; G02B 27/22; B65B 1/04

(52) U.S. Cl. 359/226.3; 359/464; 141/9

(57) ABSTRACT

An optical component deflects light beams which pass though the optical component. The optical component comprises multiple fluid cells arranged next to each other in a regular structure, and an influencing means, where a fluid cell contains at least two immiscible fluids, where an interface will form between two fluids of a fluid cell, where the interface can be given a specifiable shape and/or orientation by the influencing means, where a fluid cell comprises at least one optical medium, where the optical medium is disposed adjacent to a fluid of the fluid cell, where the shape of the surface of the optical medium which faces the adjacently arranged fluid cannot be changed, and where the optical medium serves to deflect the light beams which pass through the fluid cell by a specifiable angle.

The present invention relates to an optical component for deflecting light beams which pass though the optical component. The present invention further relates to a display having such an optical component and to a method for manufacturing such an optical component.

An optical component of the above-mentioned type is preferably used in a display or in a visual display device. In particular in an autostereoscopic display according to WO 2005/060270 A1, the actual eye positions of at least one observer are detected, and the stereoscopic images are deflected towards the left and the right eye of the observer, respectively, dependent on these actual eye positions. This is realised with the help of a backplane shutter device. However, this arrangement has the disadvantage that a large portion of the available light emitted by the light source cannot serve for the presentation of the images to be displayed. It is therefore desired to improve the luminous efficiency of such a display. Similar problems also occur in a holographic display, such as known from WO 2006/066919 A1 or WO 2006/027228 A1.

Fluid cells as such are known in the prior art. Just to cite an example, reference is made to document WO 2005/093489 A2, in which a single fluid cell is disclosed which can deflect light beams having different polarisation which pass though this fluid cell in different directions with the help of a birefringent optical medium. The fluid cell disclosed there can be used in a CD or DVD player in order to scan information from different focus layers, or to compensate uneven surfaces of an optical data carrier by way of variably focussing a light beam. The technology disclosed there also allows to optimise the contrast of images which are recorded by a microscope, where the microscope is fitted with such a fluid cell in the optical path.

It is therefore the object of the present invention to provide an optical component of the above-mentioned type which is developed such to solve the above-mentioned problems or at least to improve the situation. It is a further object of the present invention to provide a manufacturing method for an optical component of the above-mentioned type which is developed such to solve the above-mentioned problems or at least to improve the situation.

The above-mentioned object is solved with the help of the subject of claim 1. According to that, an optical component serves in particular to deflect light beams which pass through the optical component. The optical component comprises multiple fluid cells which are adjacently arranged in a regular structure and an influencing means. A fluid cell contains at least two immiscible fluids. An interface or separating layer is formed between two fluids of a fluid cell. The influencing means serves to control and/or vary the shape of the interface so to give it a specifiable form. Alternatively or additionally, the influencing means can control and/or vary the orientation of the interface. A fluid cell comprises at least one optical medium. The optical medium is disposed next to a fluid of the fluid cell. The shape of the surface of the optical medium which faces the adjacently arranged fluid cannot be changed. The optical medium serves to deflect the light beams which pass through the fluid cell by a specifiable angle. The optical media of the fluid cells of the optical component are made and/or formed such that the optical component realises an optical imaging function.

In the context of the present invention, a regular structure shall be understood to be in particular an arrangement of multiple fluid cells next to each other. The fluid cells can form a regular hexagonal, rhombic or matrix lattice structure. In the context of the present invention, a fluid can be a liquid or gaseous material, or a liquid in which a gas is dissolved. The fluid can be mixed with particles or solid matter.

The present invention is based on the finding that, by providing an optical medium adjacent to a fluid cell, the light beams which pass through the fluid cell are deflected by a certain angle which—depending on the desired application of the optical component—can be larger than would be possible without the optical medium. For example, a large deflection angle can be realised by two or more fluids in a fluid cell if the difference in the refractive index between the two is as large as possible. For this, however, one of the two fluids has to comprise a very large refractive index, e.g. n1=1.6, and the other one e.g. n2=1.3. A fluid with such a high refractive index can for example be an oil. However, such an oil comprises a high viscosity, so that the achievable switching times of the fluid cell are limited. Therefore, according to this invention, the fluid cell of the optical component is combined with the optical medium which can, due to the effect of diffraction or refraction, deflect the light beams which pass through the fluid cell by a specifiable angle, in particular by a large angle. An optical component with multiple fluid cells can thus be provided where the fluid cells realise a beam deflection by both a constant portion—caused by the transition from the optical medium to the adjacently arranged fluid—and a variable portion—caused by the interface with variable shape and orientation and the corresponding transition between the two adjacently arranged fluids of the fluid cell at that interface.

Now, the optical medium can comprise a piece of glass, a solid body, a cured polymer or an irreversibly solidified or set fluid. The following materials may be used for this: epoxy resin, polycarbonate or PMMA (polymethyl methacrylate) for forming a surface profile; photopolymer (HRF or Omnidex™ by DuPont or Tapestry™ by Bayer Material Science) for forming a coplanar graded index (GRIN) element. The optical medium can have various geometric forms. On the one hand, the optical medium can be designed as a coplanar plate which seals the fluid cells on one side. On the other hand, the optical medium can be designed as a prismatic body which seals a multitude of fluid cells. In the latter case, the optical medium realises one prism for each fluid cell. Alternatively, the optical medium can have a complex form, e.g. a composition of multiple individual rows of prismatic bodies, or be shaped in such way in a moulding process. The one face of the optical medium can here be planar, while the opposite face of the optical medium can be shaped in a toothed or triangular way.

The surface of the optical medium which faces the adjacently arranged fluid is particularly preferably substantially of planar shape. In other words, the interface of the optical medium and the adjacently arranged fluid is substantially planar. The light beams which pass through the fluid cell can thus be deflected in the same way, i.e. by substantially the same angle, across substantially the entire cross-sectional area of the cell. The cross-section relates in particular to a direction perpendicular to the optical axis of the fluid cell, or is parallel to a surface of the fluid cell through which light beams pass. This is particularly advantageous in autostereoscopic or holographic displays.

According to one embodiment of this invention, the fluid cell has an optical axis which is oriented substantially at right angles to a surface which the adjacently arranged fluid cells have in common. The beam path of the light beams which pass through the optical component does not necessarily have to be symmetric with the optical axis, although a symmetry axis (e.g. of a rotation symmetry) or a symmetry plane can exist. The optical axis can thus for example characterise the main direction of propagation of the light beams which pass through the optical component.

The light beams which pass though the fluid cell can particularly preferably be deflected by controlling and/or varying the shape of the interface and/or by controlling and/or varying the orientation of the interface in relation to the optical axis. By controlling and/or varying the shape and/or orientation of the interface, the light beams can be variably deflected and directed in a specifiable direction. This is particularly preferable when realising an autostereoscopic or holographic display, for example as known from documents WO 2005/027534 A2 or WO 2006/066919 A1 or WO 2006/027228 A1. The light can here be deflected such that the movement of the head or of eyes of an observer can be tracked, where the term ‘tracking’ is described in more detail in document WO 2006/066919 A1.

Generally, the light beams which pass through the fluid cell will be deflectable in relation to the optical axis due to the transition of the light beams from the fluid to the adjacently arranged optical medium. This can be caused by the effect of refraction if the refractive indices of the optical medium and of the adjacently arranged fluid differ. The light beams which pass through the fluid cell are refracted in a comparable way by an interface during the transition from one fluid to an adjacently arranged fluid. To achieve this, the refractive indices of the two adjacently arranged fluids preferably differ by a specifiable value, which allows a deflection range to be realised which suits the desired application of the optical component.

Now, it can be provided that the specifiable shape of an interface of adjacently arranged fluids can be controlled such to be a substantially planar, cylindrical or anamorphic shape. In other words, the interface of adjacently arranged fluids has a substantially planar, cylindrical or anamorphic shape. Preferably, the interface is provided to have a planar shape, which can be controlled by the influencing means. A prism function can thus be realised with one fluid or with multiple fluids in the fluid cell, in particular if the fluid cell comprises a rectangular or square cross-section.

To be able to operate a fluid cell using the electrowetting principle, one embodiment of the present invention provides that at least one fluid is electrically polar and/or electrically conductive and at least one further fluid of the fluid cell is not electrically polar and/or not electrically conductive. A fluid can for example be mixed with suitable salts or ions so to become electrically polar and/or electrically conductive. Alternatively, a fluid which is per se electrically polar can preferably be selected. The fluids are filled into the fluid cell such that the electrically polar and/or electrically conductive fluid comes in contact with the contact electrode.

Particularly preferably, at least two fluids of a fluid cell have a different optical refractive index. If the optical refractive indices of the two fluids differ greatly, then a large deflection angle can be realised at the interface of the two fluids. This can be desired in autostereoscopic or holographic applications too.

In particular when the optical component is used in applications where light of different wavelengths is involved, such as colour displays, it can be provided that the Abbe numbers of two fluids of a fluid cell have a high—and preferably substantially identical—value. In other words, those fluids comprise a low dispersion. Alternatively, the refractive index of at least one fluid can have a specifiable gradient. A refractive index gradient shall in particular be understood to be the dependence of the refractive index of an optical medium or a fluid on the wavelength of the light. It can for example be advantageous to provide a substantially constant refractive index gradient of at least one fluid or to use fluids which comprise a low dispersion in the used wavelength range. Further, the specifiable refractive index gradient of a fluid can be substantially opposed to that of the adjacently arranged fluid, so that achromatic conditions prevail. Alternatively, the main dispersion of two adjacently arranged fluids can be as similar as possible or mutually adapted.

Generally, controlling and/or varying the shape of the interface and/or controlling and/or varying the orientation of the interface of two fluids is based on the electrowetting principle. The influencing means generally comprises at least one contact electrode and at least one control electrode for each fluid cell. The at least one contact electrode is in contact with an electrically polar or electrically conductive fluid. An isolation layer is disposed between a control electrode and a fluid, said isolation layer having a thickness of some nm to some μm. A fluid cell is preferably fitted with 2, 4 or 8 control electrodes. All fluid cells can have a common contact electrode, which can be realised in the form of a substantially transparent, electrically conductive layer which is in direct contact with the electrically polar and/or electrically conductive fluid of each fluid cell. Such a layer can be an indium tin oxide (ITO) layer which is deposited on the inside of a common cover of the fluid cells of the optical component.

According to a particularly preferred embodiment, the optical medium is of an electrically polar and/or electrically conductive type and can thus serve itself as the contact electrode. According to this embodiment, the electrically polar and/or electrically conductive fluids of the fluid cells are in contact with the optical medium which serves as the contact electrode, or are disposed next to it. This arrangement makes the provision of a separate contact electrode in a fluid cell superfluous. If the optical medium is of a substantially plate-like form and if it seals the fluid cells from one side, the number of control electrodes will have to be provided for each fluid cell which are required to control the shape and/or orientation of the interface of the fluids in the fluid cells. The electrically polar and/or electrically conductive optical medium would thus have a constant potential while the optical component is in operation. The optical medium can be made electrically polar and/or electrically conductive during the manufacturing process by adding suitable substances, e.g. by adding ions.

Now, various embodiments of the optical medium will be described which serve to achieve a specifiable angular deflection of the light beams which pass through the fluid cell.

The optical medium is particularly preferably designed such that the light beams which pass through the fluid cell are deflected by a specifiable angle due to the effect of refraction. The optical medium can thus for example be of a substantially prismatic shape. The light beams which pass through the fluid cell can here be deflected by a specifiable angle in particular due to the effect of refraction during the transition from the optical medium to the adjacently arranged fluid at the interface of the two. The interface, or the surface of the optical medium which faces the adjacently arranged fluid, is situated at an angle to the optical axis which is different from zero degrees.

Alternatively or additionally, according to another embodiment, the optical medium can comprise a locally variable refractive index. Such a form of the optical medium is also known as gradient index. The variation in the refractive index is preferably provided in a direction across the direction of the optical axis. The deflection of the light beams which pass through the fluid cell is caused by the effect of refraction during the transition from the fluid to the adjacently arranged optical medium.

According to an alternative embodiment, the optical medium is designed such that the light beams which pass through the fluid cell are deflected by a specifiable angle due to the effect of diffraction. Accordingly, the optical medium comprises structures at which the light beams which pass through the optical medium are diffracted. The optical medium can for example comprise a grating structure at which the light beams which pass through the fluid cell and hence through the optical medium are diffracted. Said grating structure can be a volume grating or a hologram. The optical medium can further comprise a so-called blazed grating which is formed by a multitude of prismatic structures for each fluid cell. The deflection of the light beams at the prismatic structures is based on the effect of refraction. The deflection at the blazed grating is based on the effect of refraction.

If the optical medium comprises a locally variable refractive index, or if it deflects the light beams which pass through the fluid cell by a specifiable angle due to the effect of diffraction, the optical medium can particularly preferably be designed in the form of a coplanar element. This permits cost-efficient manufacture of the optical medium, in that for example a suitable coplanar layer, which is for example made of a photopolymer or a glass plate doped with rare earth metals, is given the locally variable refractive index in an irreversible exposure process. This layer must then be attached to the fluid cells which are arranged in a regular structure.

According to a preferred embodiment, the optical medium comprises at least one switchable grating which can be controlled by an influencing means, where the light beams which pass through the switchable grating can be diffracted in at least two different directions according to the actual control state. The optical medium is preferably disposed on the entry side of those fluid cells.

Now, the use of static and variably controllable gratings or volume gratings and comparable components in their function as optical media will be described in more detail.

For the purpose of achieving controllability of the diffraction efficiency of volume gratings which are to be used as optical medium, liquid crystal (LC) materials can be embedded in a polymerisable monomer-oligomer mixture which is fitted with a photo-initiation system so that it can be exposed holographically. The polymerisation displaces the LC material, whereby a segregation takes place which corresponds to a refractive index modulation.

The LC materials must be oriented by an electric field, e.g. towards an increasing orientation polarisation, i.e. they must be turned from an undirected into a directed state. The electric field can here be generated or applied by an accordingly designed influencing means. The extent of the orientation of the dipoles of the liquid crystals is proportional to the applied voltage U. The variably controllable refractive index thus depends on the applied voltage (e.g. Δn˜ΔU).

The refractive index modulation which suffices to switch from a minimum diffraction efficiency 0 to a maximum diffraction efficiency near 1 depends on the geometry of the grating and on the wavelength of the light. It is for example <0.01, so that volume gratings of that type which comprise liquid crystals can preferably be modulated in a range of >1 kHz, because the liquid crystals must only be given an excursion of few degrees in order to realise the low refractive index modulation.

If a switchable polymer dispersed liquid crystal (PDLC) type volume grating is used, the variably controllable deflection angle which is realisable with the fluid cell (e.g. with dynamic fluid cell prisms) can thus be enlarged. Since the angle and wavelength selectivity of volume gratings is sufficiently high, the grating affects substantially one given wavelength only (design wavelength) in the activated (on) state, e.g. only λg=532 nm, but neither λb=470 nm nor λr=633 nm.

For example, multiple volume gratings can be provided, in particular three gratings, where each grating is tailored to one specific design wavelength. The volume gratings are preferably designed such that all wavelengths can be deflected by the same deflection angle in a switchable manner. The plane waves which are emitted by a backlight propagate at an accordingly specifiable angle to the optical axis of the optical component or display, where the absolute value of this angle is half that of the switchable angle of the volume grating, i.e. for example −8 degrees. The switchable deflection angle is for example +16 degrees in the activated (on) state. This means that the deflection angle can thus be switched binarily between −8 degrees and +8 degrees on the entry side of the fluid cells. For this, the voltage is selected such that the diffraction efficiency is maximised for the design wavelength. The colours of the illuminating light can be assigned temporally, i.e. for example by way of switching on one grating and the corresponding design wavelength in synchronism. Alternatively, it is possible to use a combination of time division multiplexing of the switchable gratings and space division multiplexing of the colours.

It is generally also possible to use higher diffraction orders. The gratings can also be realised in the form of surface profile gratings in quartz glass into whose grooves liquid crystals are embedded. This means that there is no LC dispersion in the polymer. However, the necessary angle selectivity must be realised in this embodiment by an accordingly great etching depth, i.e. with e.g. 15 μm deep grooves. The angle and wavelength selectivity of the used grating(s), which are optimally matched to the optical component, can be realised by accordingly choosing the deflection angles, the thickness of the grating(s) and the illuminating wavelengths.

The refractive index modulations of switchable PDLC, which realise different deflection angles or reconstruction geometries for individual wavelengths, can also be exposed in one grating in an interleaved manner. By selecting the suitable voltage and the suitable refractive index modulation, it is determined for which wavelength of the light the grating is activated (on state). Generally, the control electrodes of the influencing means can be of an areal or striped design.

Generally, switchable polarisation-selective gratings can be used as well in order to realise specifiable discrete angles in a binarily switchable manner. The design angles of the volume gratings can also vary across the surface of the component or display. Each fluid cell or individual row of fluid cells can be assigned with a certain volume grating. Alternatively, all fluid cells of an optical component can be assigned with a common volume grating.

Further, the optical medium can also be designed in a switchable manner for three wavelengths with the help of multi-order blazed gratings, namely such that only one wavelength is diffracted, while the others are not. The term multi-order here relates to the required etching depth of the surface profile structure, which is e.g. to be optimised for three wavelengths here, where the LC material is embedded in these etching grooves in order to make the grating switchable. The design can also be optimised to match the switchable second order, or a switchable higher order, of the blazed grating.

LC materials can also be substituted by other materials which change their refractive index in a reversible and thus controllable manner when a voltage is applied, or when a current is flowing, or in the presence of UV radiation. If non-linear optical polymers (NLOP) are used as material which is to be embedded into the photopolymer, modulation frequencies in the range of some GHz are possible.

According to a particularly preferred embodiment, the interface and/or the fluid with the greatest refractive power is disposed last in the direction of light propagation. The interface is understood to be in particular the separating face between two adjacently arranged, different optical elements, e.g. the separating face between a fluid and the adjacently arranged optical medium, or the interface between two adjacently arranged fluids. Now, if the interface and/or the fluid with the greatest refractive power is disposed last in the direction of light propagation in or at the fluid cell, the deflection of light beams which is to be realised with that fluid cell—e.g. by the effect of refraction—takes place immediately before the light beams exit the fluid cell, seen in the context of the total distance covered in the fluid cell. This is why the portion of light which is reflected or absorbed by the fluid cell, i.e. which cannot leave the fluid cell due to total reflection or absorption by a side wall of the fluid cell, is reduced to a minimum. Trimmed edges of the light beams which pass through the fluid cell, which possibly occur due to the excursion of the beam, can thus be minimised.

As regards a display, the above-mentioned object is solved by the features of claim 20. According to this, a display serves in particular for an autostereoscopic or holographic representation of a three-dimensional scene. The display according to this invention is characterised by an optical component according to one of claims 1-20. In other words, the optical component according to this invention can be used in particular in an autostereoscopic display, for example as disclosed in document WO 2005/027534 A2, or in a holographic display, for example as disclosed in document WO 2006/066919 A1 or WO 2006/027228 A1.

The optical component is particularly preferably disposed between an element which encodes the scene information and an observer who watches the scene information. In an autostereoscopic display, respective stereoscopic images for the left and right eyes of an observer are written to the element which encodes the scene information. In a holographic display, a hologram is written to or encoded in the element which encodes the scene information, where in Fourier holography the hologram comprises the Fourier transform of a three-dimensional scene to be generated. Typically, such an element which encodes the scene information is referred to as spatial light modulator (SLM) in holography. The arrangement of the element which encodes the scene information can here be analogous to the arrangement disclosed in WO 2005/027534 A2 or WO 2006/066919 A1 or WO 2006/027228 A1 in the respective optical path of the autostereoscopic or holographic display.

According to a particularly preferred embodiment, the optical media of the fluid cells of the optical component are made and/or formed such that the optical component realises an optical imaging function. This means that the optical component can realise an optical imaging function, which includes e.g. a focussing function. A lenticular or field lens or other separate focussing element, which would usually be provided in a display, can thus be omitted, which can in particular bring about cost benefits in the manufacture and/or offer the opportunity of a more compact design of the display.

The optical imaging function can for example comprise a lens function. Examples of such an imaging function are a field lens, a facetted field lens, a cylindrical lens or a focus lens. In particular if each fluid cell has a substantially differently designed optical element, the imaging function of a facetted field lens can hereby be realised. In this case, for example the prismatic interfaces of the optical media of adjacently arranged fluid cells can comprise a slightly different angle to the optical axis.

According to a particularly preferred embodiment, the optical media of specifiable fluid cells of the optical component are designed and/or arranged such that the light beams are substantially deflectable into a first target region. Optical media of different fluid cells of the optical component are designed and/or arranged such that the light beams are substantially deflectable into a second target region. Here, a target region shall be understood in particular to be an observer eye or a specifiable area around an eye pupil. In other words, light beams are deflected towards or focussed at two different target regions, namely towards the two eyes of an observer, due to the different design of the optical media in individual fluid cells. In an autostereoscopic display (such as disclosed in document WO 2005/027534 A2), such target region is also referred to as sweet spot. In a holographic display (such as disclosed in document WO 2006/066919 A1 or WO 2006/027228 A1), such target region is also referred to as viewing window or virtual observer window. The optical media of the fluid cells are particularly preferably designed and/or arranged such that the at least two target regions are substantially arranged in a central position and at a specifiable distance to the display surface on the observer side. The two target regions can for example be situated an eye separation (about 6-8 cm) apart. Further, it is also possible that the optical media of the fluid cells are designed and/or arranged such that each of the at least two target regions are arranged in a substantially central position in at least two sub-spaces and at a specifiable distance to the display surface on the observer side. The two target regions can for example be arranged in a substantially central position in two half-spaces of the display, i.e. also about 1 m apart, and at different distances to the display. In order to enable an observer to move their head whilst watching, additional deflections of the light beams which pass through the fluid cells can be realised with the help of the fluid cells with the aim to track the at least two target regions to the actual positions of observer eyes. For this, the actual positions of the observer eyes must be detected with an position detection system, which must accordingly be provided. Based on the detected positions of the observer eyes, the fluid cells are controlled such that the light beams are deflected towards the target regions. Multiple observers can be presented with an image or three-dimensional scene by a time-shifted deflection of the light beams (time division multiplexing). Further details of following changing positions of observer eyes are described e.g. in the context of the term ‘tracking’ in document WO 2006/066919 A1.

In particular, the fluid cells of the optical component which deflect the light beams towards the first target region can be disposed in alternate arrangement or adjacently to those fluid cells of the optical component which deflect the light beams towards the second target region. The same can apply to groups of fluid cells, i.e. a first group of fluid cells of the optical component which deflect the light beams towards the first target region are disposed in alternate arrangement with those groups of fluid cells of the optical component which deflect the light beams towards the second target region. Such a group of fluid cells can for example be a matrix arrangement of 2×2 or 3×2 fluid cells. Individual fluid cells can for example be assigned to a pixel of the element which encodes the scene information which generates a certain primary colour (e.g. red, green or blue), or be spatially arranged accordingly. A colour representation can thus be realised by way of space division multiplexing of the fluid cells or individual pixels of the element which encodes the scene information. Further, a group of fluid cells can also comprise one or multiple columns of fluid cells which are arranged vertically. Similarly, a group of fluid cells can also comprise one or multiple rows of fluid cells which are arranged horizontally. The alternate arrangement of the different fluid cells or different groups of fluid cells can be provided in at least two directions, e.g. horizontally and vertically.

The viewing windows or target regions are typically provided at a specifiable distance to the display panel. This distance can substantially correspond with the focal length of the focussing means which is typically provided in the display and which serves to image a light source which is assigned to the display into the observer plane. In the holographic display disclosed in documents WO 2004/044659 A2, WO 2006/066919 A1 or WO 2006/027228 A1, the viewing windows or target regions are situated in the observer plane, or the element which encodes the scene information is encoded such that the three-dimensional scene which is created with the help of the holographic display can be watched through said viewing window or through said target region. In other words, the observer must have their eyes in the observer plane, or in the viewing windows or target regions, in order to be able to perceive the three-dimensional scene. However, the distance along the optical axis can be changed, for example by an accordingly adapted code in the element which encodes the scene information; for details on this see for example WO 2006/066919 A1, in particular what is said about ‘z tracking’. Alternatively or additionally, the fluid cells can also be controlled accordingly so to achieve a variation in the distance of the viewing windows or target regions from the display. Typically, the distance will be variable within the depth of focus range of the focussing means which is typically provided in the display. Further, a lateral variation of the viewing windows or target regions can be achieved by controlling the fluid cells accordingly.

According to a particularly preferred embodiment, the optical media of the fluid cells of the display are designed such that the achievable deflection angles of the light beams which pass through the fluid cell grow as the distance to the centre of the display panel increases. This is provided in particular if the display and in particular the optical media of the fluid cells are designed and/or arranged such that the viewing windows or target regions are arranged in a central position in respect of the display surface on the observer side. In this case, the fluid cells which are situated towards the edge of the optical component must deflect the light beams by a greater angle to reach the target region than those fluid cells which are situated in a more central position of the optical component.

As regards the method aspect, the above-mentioned object is solved by the features of claim 29 or 30. According to this, the method according to this invention serves in particular for the manufacture of an optical component according to one of claims 1 to 20. A structure with multiple fluid cells is filled at least partly with a flexible means. The flexible means is electrically polar or electrically conductive or comprises electrically polar or electrically conductive particles. The influencing means is controlled such to give the flexible means in a fluid cell a defined form. The flexible means is solidified in this condition, thus forming the optical medium (i.e. the solidified flexible material represents the optical medium). At least two immiscible fluids are then poured into the fluid cells of the structure. The fluid cells of the structure are then sealed. The optical component in accordance with one of claims 1-20 can thus be made. In particular, this method according to the invention serves to make the optical component where the optical medium is of an electrically polar and/or electrically conductive type, and where the optical medium serves as the contact electrode.

The inventive method according to claim 30 also serves in particular for the manufacture of an optical component according to one of claims 1-20. A structure with multiple fluid cells is filled at least partly with a flexible means and with a fluid which is immiscible with the former. An interface will form between the flexible mans and the fluid. Either the flexible means or the fluid is electrically polar or electrically conductive or comprises electrically polar or electrically conductive particles. The influencing means is controlled such that the interface and thus the flexible means in a fluid cell is given a defined form. The flexible means is solidified in this condition, thus forming the optical medium (i.e. the solidified flexible material represents the optical medium). At least one further fluid can then be poured into the fluid cells of the structure. The fluid cells of the structure are then sealed. In particular the optical component in accordance with one of claims 1 to 20 can thus be made. This method according to this invention serves to make an optical component where the optical medium is not electrically polar and/or not electrically conductive, since the electrical polarity and/or electrical conduction, which is necessary for the electrowetting principle, is provided by the one fluid.

In the context of the present invention, a structure shall be understood to be in particular a part of the fluid cells which form the optical component. This can for example be individual rows or columns of fluid cells of the optical component, where the fluid cells can be arranged in a matrix.

It is particularly preferably provided that the definable shape of the flexible means has a substantially planar surface which faces an adjacently arranged fluid. After its solidification, a thus shaped flexible means represents a substantially prismatic optical medium. The orientation of the planar surface of the flexible means of each fluid cell can be controlled variably in a specifiable manner—provided the influencing means being controlled accordingly during the manufacturing process. The optical media of the fluid cells can thus be designed or formed such that hereby for example the optical imaging function of a facetted field lens is achieved.

It is of course also possible that the flexible means comprises different shapes and/or orientations in individual fluid cells. For example, fluid cells can be provided where the surface of the flexible means—and thus the surface of the optical medium after solidification of the flexible means—is of substantially cylindrical or anamorphic shape.

The solidification of the flexible means can be realised with the help of a photochemical reaction or with a catalytic curing reaction. A photochemical reaction can for example be initiated by exposing a flexible means in form of a liquid polymer to ultraviolet (UV) radiation. Naturally, this implies that the initially liquid polymer comprises suitable material properties, namely to solidify upon exposure to light of a specifiable wavelength.

Now, there are a number of possibilities for embodying and continuing the teachings of the present invention. To this end, reference is made on the one hand to the dependent claims that follow the respective independent claims, and on the other hand to the description of the preferred embodiments of this invention below including the accompanying drawings. Generally preferred physical forms and continuations of the teaching will be explained in conjunction with the description of the preferred embodiments of the invention and the accompanying drawings. The Figures are schematic drawings, where

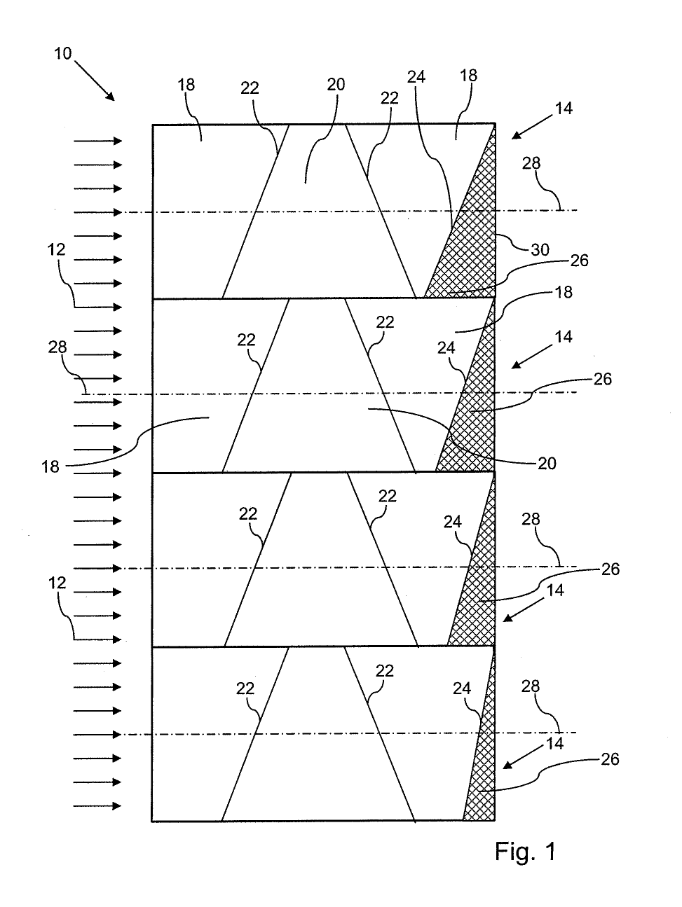

FIG. 1 is a sectional side view which illustrates an embodiment of several fluid cells of an optical component according to this invention,

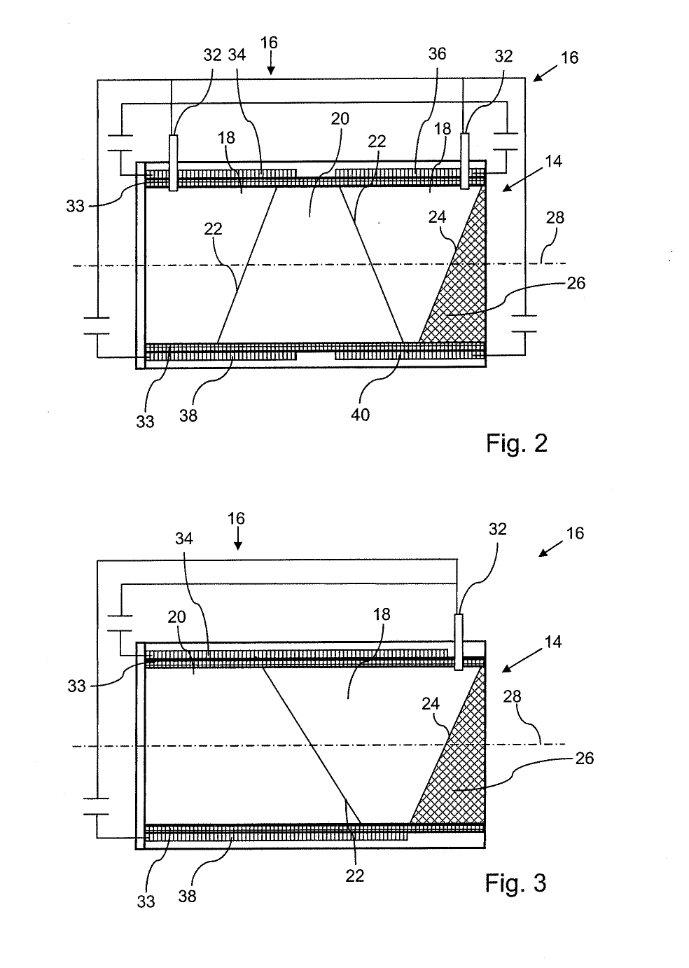

FIGS. 2 and 3 are sectional side views which illustrate further embodiments of a fluid cell, showing a part of the influencing means,

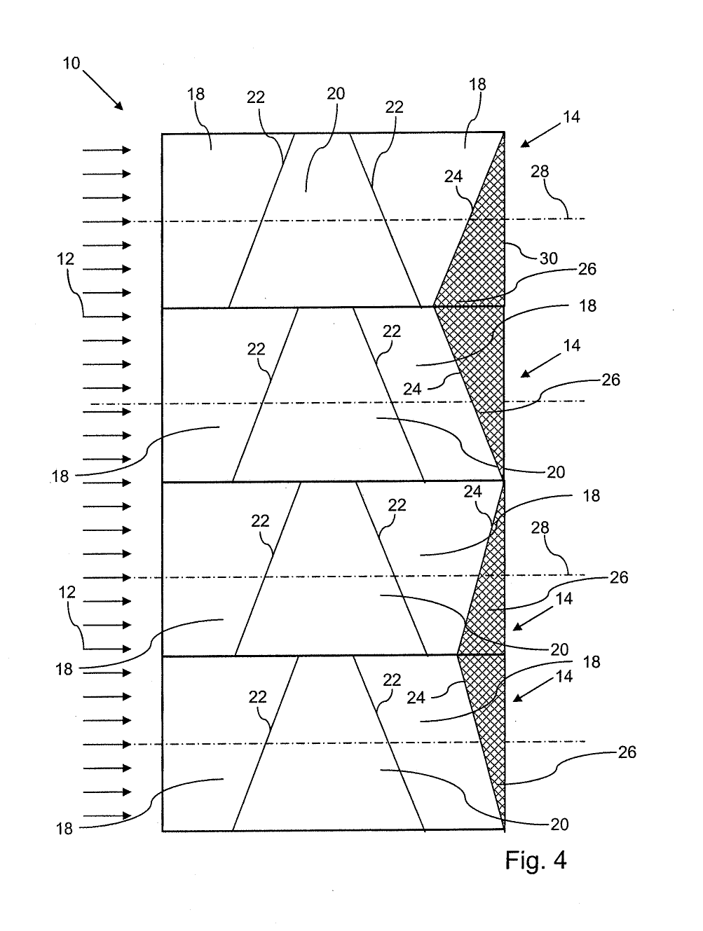

FIG. 4 is a sectional side view which illustrates a further embodiment of several fluid cells of an optical component according to this invention,

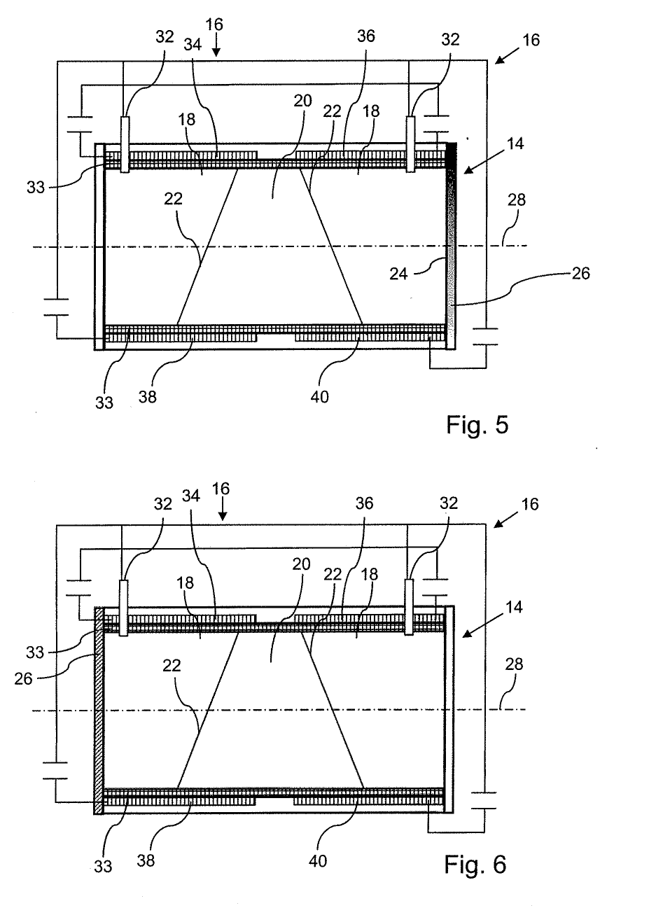

FIGS. 5 and 6 are sectional side views which illustrate further embodiments of a fluid cell, showing a part of the influencing means,

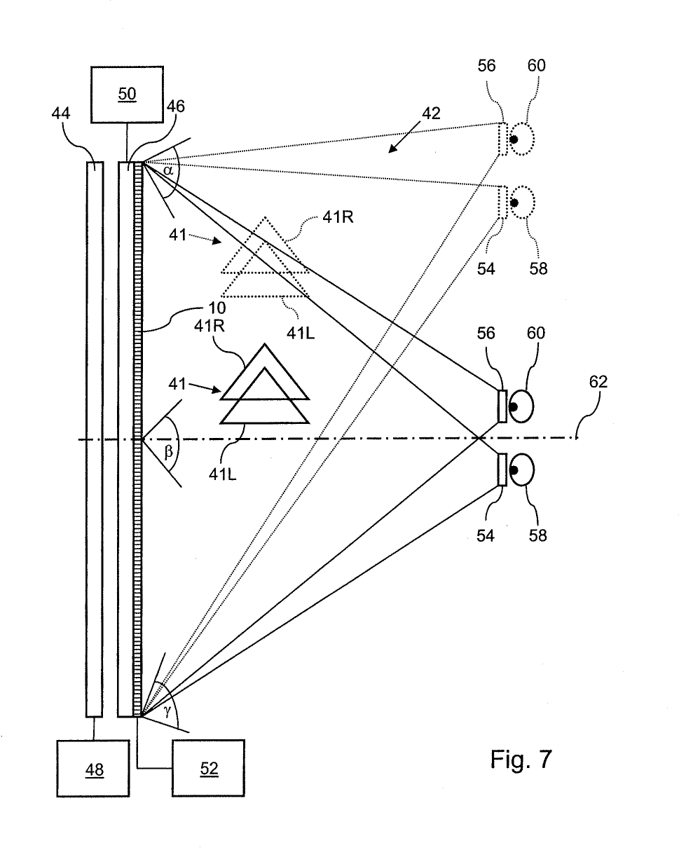

FIG. 7 is a top view which illustrates an embodiment of a display according to this invention,

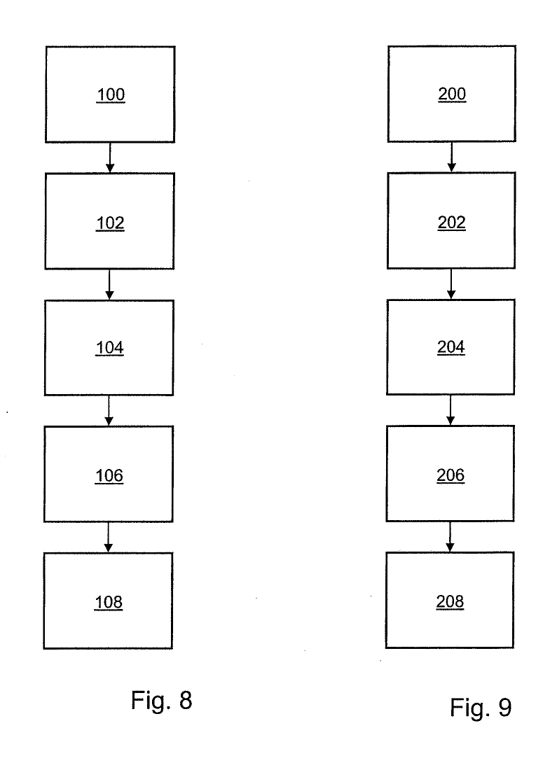

FIGS. 8 and 9 are schematic flow charts, each of which illustrating a method for manufacturing the component according to this invention, and

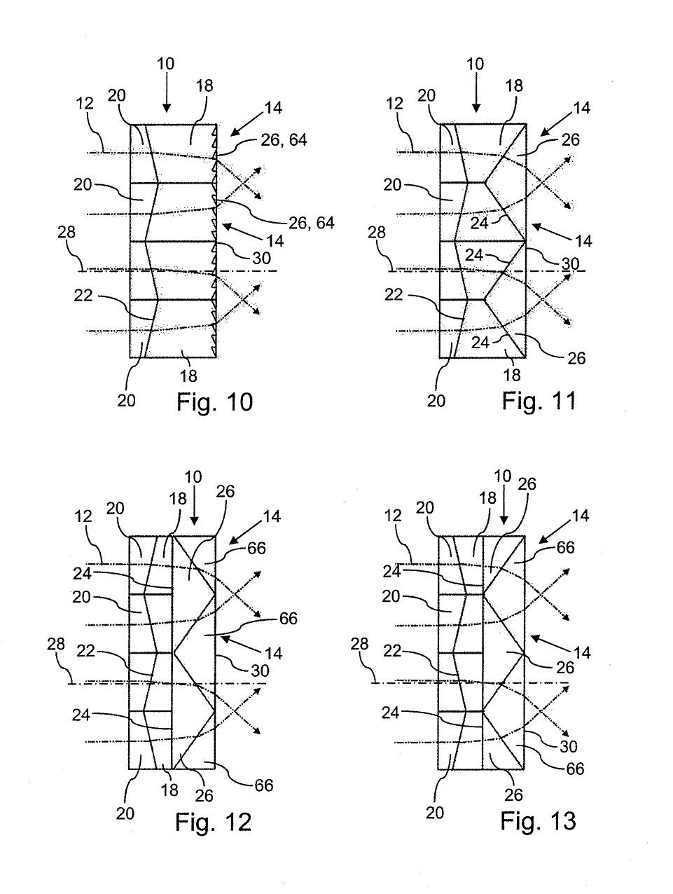

FIGS. 10 to 17 are a sectional side views each of which illustrating a further embodiment of several fluid cells of an optical component according to this invention.

Identical or comparable parts are given like numerals in all Figures.

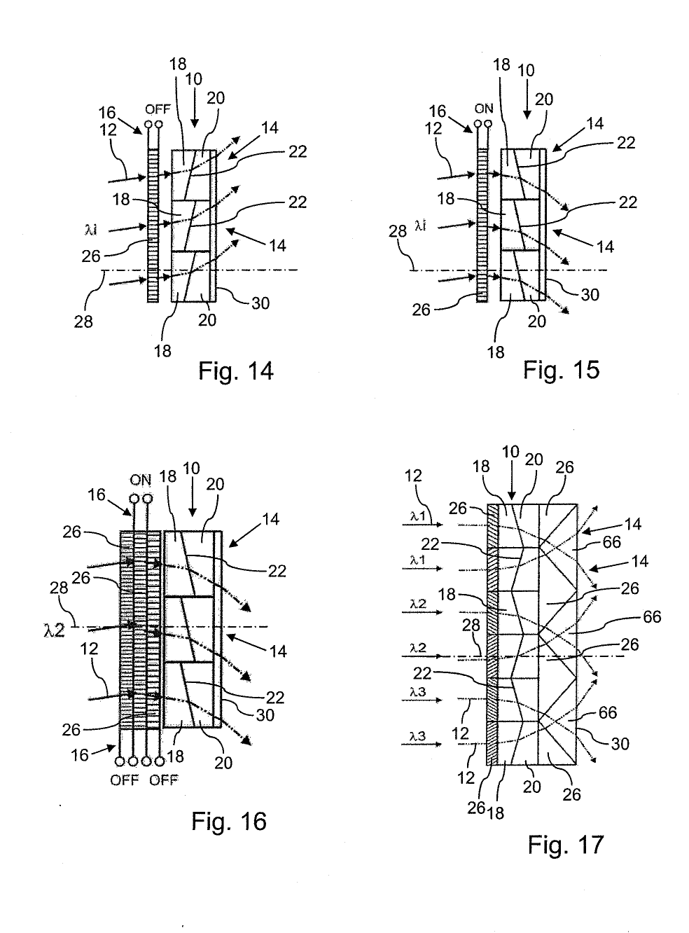

In FIGS. 1, 4, 7 and 10 to 17, the optical component is denoted by the numeral 10. Light beams 12 which pass through the optical component 10 can be deflected by the latter. The optical component 10 according to FIGS. 1, 4 and 10 to 17 comprises multiple fluid cells 14, which are arranged next to each other in a regular structure, and an influencing means 16, which is for example shown in FIG. 2. Each of FIGS. 1, 4 and 10 to 13 just shows four fluid cells 14, which represent a part of a row of the optical component 10. FIGS. 14 to 16 show three fluid cells 14 each. FIG. 17 shows 6 fluid cells 14. Further fluid cells (not shown) are disposed at the top and bottom ends in FIGS. 1, 4 and 10 to 17. Further rows of fluid cells are provided above and underneath the drawing plane. A fluid cell 14 contains at least two immiscible fluids 18, 20. Because the two fluids 18, 20 are immiscible, an interface 22 will form between two fluids 18, 20 of a fluid cell 14. The interface 22 can be given a specifiable shape and/or orientation by the influencing means 16. A fluid cell 14 comprises at least one optical medium 26, which is arranged adjacent to a fluid 18 of the fluid cell 14. The shape of the surface 24 of the optical medium 26 which faces the adjacently arranged fluid 18 cannot be changed. The optical medium 26 serves to deflect the light beams 12 which pass through the fluid cell 14 by a specifiable angle. The fluid cells 14 which are shown in FIGS. 1 and 4 have partition walls which are indicated only schematically in these drawings; these partition walls are shown in more detail for example in FIGS. 2 and 3.

The optical medium 26 of the fluid cells 14 which are shown in FIGS. 1 and 4 is made of a cured polymer. The surface 24 of the optical medium 26 which faces the adjacently arranged fluid 18 is of substantially planar shape. The fluid cell 14 has an optical axis 28 which is oriented substantially at right angles to a surface 30 which the adjacently arranged fluid cells 14 have in common.

The light beams 12 which pass though the fluid cell 14 can be deflected by controlling and/or varying the shape of the interface 22 and/or by controlling and/or varying the orientation of the interface 22 in relation to the optical axis 28. This applies to the one interface 22 of the fluid cell 14 of FIG. 3, and to both interfaces 22 provided in a fluid cell 14 which can be controlled and/or oriented irrespective of each other. Further, the light beams 12 which pass through the fluid cell 14 can be deflected in relation to the optical axis 28 due to the transition of the light beams 12 from the fluid 18 to the adjacently arranged optical medium 26. In the fluid cells 14 which are shown in FIGS. 1 to 4, this deflection is takes place based on the law of refraction.

In FIGS. 1 to 6, the interfaces 22 of adjacently arranged fluids 18, 20, which are shown in a sectional side view, are of substantially planar shape. An interface 22 can alternatively have a cylindrical or anamorphic shape, if the influencing means is controlled accordingly.

Generally, at least one fluid of a fluid cell 14 is electrically polar and/or electrically conductive, and another fluid is not electrically polar and/or not electrically conductive. In particular in the fluid cells 14 which are shown in FIGS. 2 and 3, the fluid 18 is always electrically polar while the fluid 20 is not electrically polar. The fluids 18, 20 of the fluid cells 14 which are shown in FIGS. 1 to 6 comprise a different refractive index.

In the fluid cells 14 of the optical component 10 which are shown in FIGS. 1 to 6, controlling and/or varying the shape of the interface 22 and/or controlling and/or varying the orientation of the interface 22 of two or three fluids 18, 20 is based on the electrowetting principle. The influencing means 16 comprises at least one contact electrode 32 and at least one control electrode 34, 36, 38, 40 for each fluid cell 14. The fluid cell 14 which is shown in FIG. 2 has two contact electrodes 32 and altogether four control electrodes 34, 36, 38, 40, namely two control electrodes per side wall. However, it is also possible that the fluid cell 14 only has one control electrode per side wall. On the side wall of the fluid cell 14, isolation layers 33 are disposed between the fluids 18, 20 and the control electrodes 34, 36, 38, 40. The contact electrode 32 is in contact with an electrically polar or electrically conductive fluid 18. Alternatively, for example the optical medium 26 of the fluid cell 14 which is shown in FIG. 3 can be electrically polar and/or electrically conductive, thereby fulfilling the function of a contact electrode. In such case, a contact electrode 23 as shown in FIG. 3 can be omitted. The optical medium 26 which serves as contact electrode must then be connected in an electrically suitable manner with the electric circuitry of the influencing means 16.

The part of the influencing means 16, which is shown only schematically in FIGS. 2, 3, 5 and 6, and which is accordingly assigned to the fluid cells 14 which are shown there, comprises conductors which provide electrical contact to the individual control electrodes 34, 36, 38 and 40, and to the contact electrode 32. The influencing means 16 is designed such that specifiable, but variable voltages can be applied between the at least one contact electrode 32 and each control electrode 34, 36, 38 and 40 of the same fluid cell 14. This can be a DC or AC voltage.

The optical medium 26 of the fluid cells 14 which are shown in FIGS. 1 to 4 is of substantially prismatic shape. The light beams 12 which pass through the fluid cells 14 are deflected or refracted by a specifiable angle at the interface 24 due to the effect of refraction.

The fluid cell 14 which is shown in FIG. 5 is substantially comparable to the fluid cell 14 which is shown in FIG. 2. However, the optical medium 26 of the fluid cell 14 which is shown in FIG. 5 has the form of a coplanar element which has a locally variable refractive index, a so-called gradient index. This is indicated by the greyscale gradient in the coplanar element in FIG. 5, where the refractive index gradient does not necessarily have to be linear—as indicated in FIG. 5—but this element can also be comprise periodically increasing or decreasing refractive indices. In this embodiment, the variation in the refractive index is provided in a direction across the direction of the optical axis 28. Accordingly, the deflection of the light beams 12 which pass through the fluid cell 14 is based on the effect of refraction of light which occurs during the transition from the fluid 18 to the optical medium 26, where the amount of refraction is constant according to the refractive index gradient in the optical medium 26, but which differs depending on the actual position across the direction of the optical axis 28.

In the embodiment of the fluid cell 14 which is illustrated in FIG. 6, the optical medium 26 is designed such that the optical medium 26 deflects the light beams 12 which pass through the fluid cell 14 by a specifiable angle due to the effect of diffraction. In particular, the optical medium 26 comprises a grating structure at which the light beams 12 which pass through the fluid cell 14 are diffracted. In this fluid cell 14, the optical medium 26 is also designed in the form of a coplanar element, but it is disposed on the light entry side.

In the fluid cells 14 which are shown in FIGS. 1 to 4, the interface 24 which comprises the greatest refractive power is disposed last in the propagation direction of the light or of the light beams 12.

FIG. 7 is a top view that shows an embodiment of a display 42 according to this invention for autostereoscopically or holographically representing a three-dimensional scene 41. The display 42 comprises an optical component 10 which includes fluid cells 14 as shown in FIG. 4. The display 42 further comprises an illumination unit 44 and an element 46 which encodes the scene information, both being indicated schematically in the drawing. The illumination unit 44 can comprise at least one light source, which can be a laser or at least one light emitting diode (LED). If the display 42 serves for a holographic representation of a three-dimensional scene 41, then the at least one light source of the illumination unit 44 is designed such that it emits coherent light. However, this will not be necessary if the display 42 serves for a stereoscopic representation of a three-dimensional scene. The element 46 which encodes the scene information can include a spatial light modulator (SLM) which can vary or modulate the amplitude and/or phase of the light emitted by the illumination unit 44 over the time, depending on the spatial position of the SLM. An SLM can for example be an electronically addressable SLM (EASLM) or an optically addressable SLM (OASLM). A liquid crystal device (LCD) serves as an example of an EASLM. The illumination unit 44 is controlled by the control unit 48. The element 46 which encodes the scene information is controlled by the control unit 50. The optical component 10 is controlled by the control unit 52 and by the influencing means 16 (not shown in FIG. 7).

The optical component 10 is disposed between the element 46 which encodes the scene information and an observer (not shown) who watches the scene information. The element 46 is disposed between the optical component 10 and the illumination unit 44. The light which is emitted by the illumination unit 44 thus passes the element 46 which encodes the scene information and the optical component 10. In this embodiment, each pixel of the SLM 46 is assigned to one fluid cell 14.

The optical media 26 of the fluid cells 14 of the optical component 10 are made and formed such that the optical component 10 realises an optical imaging function. The optical imaging function of the optical component 10 of FIG. 7 has the function of a lens, in particular that of a facetted field lens. In the display 42 which is shown in FIG. 7, this is realised as follows:

The optical media 26 of specifiable fluid cells 14 of the optical component 10 are designed and arranged such that the light beams 12 which pass through these fluid cells 14 are deflected substantially into a first target region 54. The optical component 10 further comprises fluid cells 14 which differ from those above and which are designed and arranged such that the light beams 12 are deflected substantially towards a direction which differs from the first direction, namely into a second target region 56. In the case of a holographic display according to WO 2006/066919 A1, the two target regions 54, 56 are viewing windows which are situated in a plane in which an observer must position their eyes in order to be able to perceive the represented or reconstructed scene 41. In particular, this is the focal plane of the lens function of the display 42. The left and right eyes of the observer are denoted by the numerals 58, 60, respectively. The display 42 is designed such that it visualises a three-dimensional scene 41 (shown in a simplified manner as a three-dimensional prism in FIG. 7) for an observer in that the SLM 46 is encoded with adequate data such that the three-dimensional scene 41L is generated for the left target region 54 and thus for the left observer eye 58, and that the three-dimensional scene 41R is generated for the right target region 58 and thus for the right observer eye 60. The three-dimensional scene 41L and the three-dimensional scene 41R are generated at the same spatial position, but are shown separate in the drawing for better understanding. Although the two three-dimensional scenes 41L, 41R are spatially overlapping, this does not impair the visual perception of the three-dimensional scene 41, because the light beams which originate in the three-dimensional scene 41L propagate exclusively into the first target region 54, and the light beams which originate in the three-dimensional scene 41R propagate exclusively into the second target region 56. If the observer and thus their eyes move relative to the display 42, the light beams will be deflected by the fluid cells 14 towards the new positions of the target regions 54, 56. This is realised with the help of the variably controllable interfaces 22 of the fluid cells 14. The target regions 54, 56 and observer eyes 58, 60 which are drawn with dotted lines in FIG. 7 serve as examples of a new observer position. Accordingly, the three-dimensional scenes 41L, 41R can also be shifted to a different position, again indicated by dotted lines in the drawing.

Groups of fluid cells 14 of the optical component 10 which deflect the light beams 12 towards the first target region 54 are disposed in alternate arrangement to those groups of fluid cells 14 of the optical component 10 which deflect the light beams 12 towards the second target region 56. This is shown schematically in FIG. 4. The first and the third fluid cell 14 (from top to bottom) in FIG. 4, as well as those fluid cells 14 which are situated in front of and behind them, here belong to the group of fluid cells 14 of the optical component 10 which deflect the light beams 12 into the first target region 54. Here, the surface 24 of the optical medium 26 is substantially oriented in a first direction. The second and the fourth fluid cell 14 (from top to bottom) in FIG. 4, as well as those fluid cells 14 which are situated in front of and behind them, here belong to the other group of fluid cells 14, which deflect the light beams 12 into the second target region 56. The second surface 24 of the optical media 26 of those fluid cells 14 is here substantially oriented in a second direction. The surfaces 24 of the optical media 26 of the fluid cells 14 of a group can have a slightly different inclination angle in relation to the respective optical axes 28. Generally, it is provided that the surfaces 24 of the optical media 26 of the fluid cells 14, which are situated towards the edge of the optical component 10, comprise a larger inclination angle in relation to the respective optical axis 28 than those fluid cells 14 which are rather situated in a more central position of the optical component 10, and thus close to the optical axis 62 of the display 42. The optical media 26 of the fluid cells 14 of the display 42 are thus designed such that the achievable deflection angles of the light beams 12 which pass through the fluid cell 14 grow as the distance to the centre of the display panel increases. The two groups of fluid cells 14 of the optical component 10 in FIG. 7 are disposed in alternate arrangement vertically. The light beams 12 are thus deflectable in different horizontal directions, namely substantially into the two target regions 54, 56, by the optical media 26 of the fluid cells 14 of the optical component 10.

The two different positions of the observer eyes 58, 60 which are shown in FIG. 7 make clear that the fluid cells 14 must be able to cover different deflection angle ranges, depending on their spatial position in the optical component 10. Fluid cells 14 which are situated in a central position, i.e. near the optical axis 62 of the display 42, must be able to deflect light beams by substantially the same absolute angle both to the left and to the right in the horizontal direction. The entire deflection angle range of such fluid cells 14 is indicated schematically and denoted with the Greek letter β. Fluid cells 14 which are situated on the right-hand side of the display 42 must be able to deflect light beams by a rather small absolute angle to the right, but by a much larger absolute angle to the left in the horizontal direction. The entire deflection angle range of such fluid cells 14 is indicated schematically and denoted with the Greek letter α. Fluid cells 14 which are situated on the left-hand side of the display 42 must be able to deflect light beams by a rather small absolute angle to the left, but by a much larger absolute angle to the right in the horizontal direction. The entire deflection angle range of such fluid cells 14 is indicated schematically and denoted with the Greek letter γ. This can be realised in that the optical media 26 of the individual fluid cells 14 of the optical component 10 are designed such that—in a neutral position of the interfaces 22—the light is deflected substantially in the direction of the bisector of the deflection angle range of the respective fluid cell 14.

If the fluid cells 14 are to deflect the light beams 12 also in the vertical direction towards the two target regions 54, 56, depending on their vertical position in the optical component 10, then the surfaces 24 of the individual optical media 26 of the fluid cells 14 must additionally be given different inclination angles in relation to the respective optical axis 28.

FIG. 8 shows a flow chart which illustrates the method according to this invention for manufacturing an optical component 10 according to claim 29. In the first process step 100, a structure with multiple fluid cells 14 is filled at least partly with a flexible means. The flexible means is electrically polar or electrically conductive or comprises electrically polar or electrically conductive particles. In the next process step 102, the influencing means 16 is controlled such to give the flexible means a defined form. In process step 104, the flexible means is solidified in this condition. The optical medium 26 is thereby created. In process step 106, at least two immiscible fluids 18, 20 are then poured into the fluid cells 14 of the structure. In process step 108, the fluid cells 14 of the structure are sealed.

FIG. 9 shows a flow chart which illustrates the method according to this invention for manufacturing an optical component according to claim 30. In process step 200, a structure with multiple fluid cells 14 is filled at least partly with a flexible means and with a fluid which is immiscible with the former. An interface 22 will form between the flexible mans and the fluid. Either the flexible means or the fluid is electrically polar or electrically conductive or comprises electrically polar or electrically conductive particles. In process step 202, the influencing means 16 is controlled such to give the interface 22 and thus the flexible means a defined form. In process step 204, the flexible means is solidified in this condition. The optical medium 26 is thereby created. In process step 206, at least one further fluid can be poured into the fluid cells 14 of the structure. In process step 208, the fluid cells 14 of the structure are sealed.

If the specifiable form of the flexible means includes a substantially planar surface 24 which faces an adjacently arranged fluid 18, then a fluid cell 14 as shown in FIGS. 1 to 4 can thereby be created.

The solidification of the flexible means can be realised in the process steps 104 or 204 with the help of a photochemical reaction or with a catalytic curing reaction.

FIGS. 10 to 13 are a sectional side views each of which illustrating a further embodiment of several fluid cells 14 of an optical component 10 according to this invention. The fluid cells 14 are each filled with two fluids 18, 20. The refractive index of the optical media 26 can be matched to the refractive index of the respective adjacently arranged fluid 18 or only differ insignificantly from the former. In the fluid cells 14 which are shown in FIGS. 11 to 13, the interface 24 which faces the fluid 18 can preferably be coated with an oxide layer (e.g. SiO₂, Al₂O₃, not shown), which serves as a diffusion blocking layer for the respective fluid 18.

The optical medium 26 of the fluid cells 14 which are shown in FIG. 10 comprises structures 64 at which the light beams which pass though the optical medium 26 are diffracted and refracted. This is because the optical medium 26 of each fluid cell 14 has a multitude of prismatic structures 64, which is also referred to as ‘blazed grating’. The oblique surfaces of two adjacent prismatic structures 64 which face the fluid 18 are oriented in opposite directions.

The fluid cells 14 which are shown in FIG. 11 compare to the fluid cells 14 which are shown in FIG. 4 as regards the optical medium 26. The optical media 26 of two adjacently arranged fluid cells 14 are made as one part.

The fluid cells 14 which are shown in FIGS. 12 and 13 have optical media 26 of a substantially coplanar type, where the optical media 26 are supplemented by additional prismatic parts 66 so to form coplanar elements. The refractive index of the optical medium 26 differs from that of the additional prismatic parts 66. In these embodiments, the optical medium 26 can be a polymer, and the additional prismatic parts 66 can be a piece of glass or a polymer. The achievable refractive index variation Δn of this element can be greater than 0.4. To be able to use the optical component 10 according to this invention in a holographic display, a layer thickness of the coplanar element which is smaller than the height of the fluid cells 14 can thus be achieved. The control electrodes (not shown in FIGS. 12 and 13) can be connected to a backplane (not shown) and thus with a control unit 52 (not shown in FIGS. 12 and 13) through contact holes which run through the fix double prism layer or through the coplanar element. In the fluid cells 14 which are shown in FIG. 12, the refractive indices of the fluid 20 and of the additional prismatic parts 66 both have a low value. The refractive indices of the fluid 18 and of the optical media 26 both have a high value. In the fluid cells 14 which are shown in FIG. 13, the refractive indices of the fluid 20 and of the additional prismatic parts 66 both have a high value. The refractive indices of the fluid 18 and of the optical media 26 both have a low value. Referring to FIGS. 10 to 13, the light beams which are emitted by the respective fluid cells 14 upwards or downwards at oblique angles are substantially deflected towards two target regions (not shown in these drawings). Each target region is located in a half-space and is positioned at a specifiable distance to the surface of the display panel on the observer side.

The fluid cells 14 which are shown in FIGS. 14 to 17 only comprise two different fluids 18, 20. FIG. 14 shows an optical component 10 with an optical medium 26 in a first operational situation; and FIG. 15 shows said component in a second operational situation. Referring to FIGS. 14 and 15, the optical medium 26 is only shown at a distance to the fluid cells 14 in the drawing for the sake of clarity. As a matter of fact, the optical medium 26 is adjoined to the fluid cells 14 without any gap. The optical medium 26 of the fluid cell 14 which is shown in FIGS. 14 and 15 is designed in the form of a controllable grating which—dependent on the control state (indicated in the drawing by the electrical connections and the denotation of the operational status with the words ‘ON’ and ‘OFF’)—transmits the light beams 12 with the wavelength λi which pass through the switchable grating either undiffracted, as shown in FIG. 14, or deflected or diffracted by a specifiable angle, as shown in FIG. 15. The switchable grating is thus designed such that the light beams 12 are deflected by 0 degrees or by −16 degrees, respectively, dependent on the actual control state. The optical medium 26 is disposed on the entry side of those fluid cells 14.

FIGS. 14 and 15 illustrate the use of a switchable PDLC volume grating as optical medium 26. Since the angle and wavelength selectivity of volume gratings is high, the volume grating only affects the design wavelength, i.e. for example only λi or λg=532 nm, but neither λb=470 nm nor λr=633 nm, in the on state. The volume grating which is shown in FIGS. 14 and 15 can be one of three volume gratings each of which being designed for a certain design wavelength, such that an identical deflection angle is realised in a switchable way for all wavelengths. This is shown in FIG. 16. The plane waves which are emitted by the illumination unit (not shown) propagate at an angle relative to the optical axis 28 whose absolute value is half that of the switchable angle, i.e. −8 degrees. The switchable deflection angle is 16 degrees in the on state. In the operational situation of the optical component 10 which is shown in FIG. 16, only the centrally situated volume grating, or the corresponding optical medium 26, is activated. Accordingly, only the wavelength λ2 is deflected by an angle of 16 degrees. This means that the deflection angle can thus be switched binarily between −8 degrees and +8 degrees relative to the optical axis 28 on the entry side of the fluid cells 14. The electric voltage which is applied to the three volume gratings is selected such that the diffraction efficiency is maximised for the respective design wavelength. The colours can be assigned temporally, i.e. for example by way of switching on one grating and the corresponding design wavelength in synchronism (time division multiplexing). Alternatively, it is possible to use a combination of time division multiplexing of the switchable gratings and space division multiplexing of the colours.

FIG. 17 illustrates the space division multiplexing of optical media 26 in the form of volume gratings, which can be of a static or switchable type, e.g. as PDLC. The volume gratings are disposed on the entry side of the fluid cells 14. With this kind of space division multiplexing, the optical component 10 can be fitted with colour filters (not shown) arranged in stripes, which is indicated in the drawing by incident light of different wavelengths (namely λ1=532 nm, λ2=470 nm and λ3=633 nm). Here, each fluid cell 14 is assigned with a separate optical medium 26 in the form of a switchable volume grating. Each switchable volume grating is matched to the respective wavelength of the light and can thus deflect the wavelength of the illuminating light which is assigned to this volume grating. The control electrodes (not shown) for controlling the volume gratings can be arranged areally or in stripes, and they can be made of transparent material, e.g. ITO. In addition to the optical media 26 in the form of volume gratings which are disposed on the entry side, the fluid cells 14 of the optical component 10 which is shown in FIG. 17 include the optical media 26 in the form of prisms which are disposed on the exit side. Together with the additional prismatic parts 66, this section of the optical component 10 is comparable with the optical components 10 which have been described above in the embodiments that correspond with FIGS. 12 and 13.

The ‘ON’ and ‘OFF’ states of the switchable gratings which are shown in FIGS. 14 and 15 can also be generated by an UV LED if the LC material is replaced by a material which changes its refractive index dependent on the intensity of the illumination of the material with UV radiation. It is thus possible to realise an optical control of switchable gratings.

Finally, it must be said that the embodiments described above shall solely be understood to illustrate the claimed teaching, but that the claimed teaching is not limited to these embodiments.

1. Optical component for deflecting light beams which pass through the optical component, with multiple fluid cells, which are arranged next to each other in a regular structure, and an influencing means, where a fluid cell contains at least two immiscible fluids, where an interface will form between two fluids of a fluid cell, where the interface is given a specifiable shape and/or orientation by the influencing means, where a fluid cell comprises at least one optical medium, where the optical medium is disposed adjacent to a fluid of the fluid cell, where the shape of the surface of the optical medium which faces the adjacently arranged fluid cannot be changed, where the optical medium serves to deflect the light beams which pass through the fluid cell by a specifiable angle and where the optical media of the fluid cells of the optical component are made and/or formed such that the optical component realises an optical imaging function.

2. Optical component according to claim 1, where the optical medium comprises a piece of glass, a solid body, a cured polymer or an irreversibly solidified fluid or where the surface of the optical medium which faces the adjacently arranged fluid is substantially of planar shape.

3-4. (canceled)

5. Optical component according to claim 1, where the light beams which pass though the fluid cell are deflected by controlling or varying the shape of the interface or by controlling and/or varying the orientation of the interface in relation to an optical axis of the fluid cell, the optical axis being oriented substantially at right angles to a surface which the adjacently arranged fluid cells have in common.

6. Optical component according to claim 1, where the light beams which pass through the fluid cell are deflected in relation to an optical axis of the fluid cell due to the transition of the light beams from the fluid to the adjacently arranged optical medium, the optical axis being oriented substantially at right angles to a surface which the adjacently arranged fluid cells have in common.

7. Optical component according to claim 1, where the light beams which pass through the fluid cell are refracted by an interface during the transition from one fluid to an adjacently arranged fluid.

8. Optical component according to claim 1, where the specifiable shape of an interface of adjacently arranged fluids is controlled such to be a substantially planar, cylindrical or anamorphic shape.

9. (canceled)

10. Optical component according to claim 1, where at least two fluids of a fluid cell comprise different optical refractive indices or where the Abbe numbers of two fluids of a fluid cell have a high value or where the refractive index of at least one fluid has a specifiable gradient.

11. (canceled)

12. Optical component according to claim 1, where controlling or varying the shape of the interface or controlling or varying the orientation of the interface of two fluids is based on the electrowetting principle, where the influencing means generally comprises at least one contact electrode and at least one control electrode for each fluid cell and where the at least one contact electrode is in contact with an electrically polar or electrically conductive fluid.

13. Optical component according to claim 1, where the optical medium is of an electrically polar or electrically conductive type, thus serving itself as the contact electrode (32).

14. Optical component according to claim 1, where the optical medium is designed such that the light beams which pass through the fluid cell are deflected by a specifiable angle due to the effect of refraction or where the optical medium is of substantially prismatic shape or where the optical medium comprises a locally variable refractive index, where the variation in the refractive index is preferably provided in a direction across the direction of the optical axis.

15. (canceled)

16. Optical component according to claim 1, where the optical medium is designed such that the optical medium deflects the light beams which pass through the fluid cell by a specifiable angle due to the effect of diffraction.

17. Optical component according to claim 16, where the optical medium comprises a grating structure at which the light beams which pass through the fluid cell are diffracted or where the optical medium is designed in the form of a coplanar element.

18. (canceled)

19. Optical component according to claim 14, where the optical medium comprises at least one switchable grating which is controlled by an influencing means, where the light beams which pass through the switchable grating are diffracted in at least two different directions according to the actual control state.

20. Optical component according to claim 1, where the interface or the fluid with the greatest refractive power is disposed last in the direction of light propagation.

21. Display for autostereoscopically or holographically representing a three-dimensional scene, characterised by an optical component according to claim 1.

22. Display according to claim 21, where the optical component is disposed between an element which encodes the scene information and an observer who watches the scene information.

23. Display according to claim 21, where the optical media of the fluid cells of the optical component are made or formed such that the optical component realises an optical imaging function or where the optical imaging function includes a lens function, in particular that of a field lens, a facetted field lens, a cylindrical lens or a focus lens.

24. (canceled)

25. Display according to claim 21, where the optical media of specifiable fluid cells of the optical component are designed or arranged such that the light beams are substantially deflectable into a first target region and where different fluid cells of the optical component are designed or arranged such that the light beams are substantially deflectable into a direction which differs from the first direction, namely into a second target region.

26. Display according to claim 25, where the fluid cells or groups of fluid cells of the optical component which deflect the light beams towards the first target region are disposed in alternate arrangement to those fluid cells of the optical component which deflect the light beams towards the second target region or where the alternate arrangement of the different types of fluid cells is provided in at least two different directions, e.g. horizontally and vertically.

27. (canceled)

28. Display according to claim 21, where the optical media of the fluid cells of the display are designed such that the achievable deflection angles of the light beams which pass through the fluid cell grow as the distance to the centre of the display panel increases.

29. Method for manufacturing an optical component according to claim 1, where a structure of multiple fluid cells is filled at least partly with a flexible means, where the flexible means is electrically polar or electrically conductive or comprises electrically polar or electrically conductive particles, where the influencing means is controlled such to give the flexible means a defined form, where the flexible means is solidified in this condition, thus forming the optical medium, where at least two immiscible fluids are poured into the fluid cells of the structure, where the fluid cells of the structure are sealed and where the optical component according to claim 1 can thus be made.

30. Method for manufacturing an optical component according to claim 1, where a structure of multiple fluid cells is filled at least partly with a flexible means and with a fluid which is immiscible with the former, where an interface will form between the flexible mans and the fluid, where the flexible means or the fluid is electrically polar or electrically conductive or comprises electrically polar or electrically conductive particles, where the influencing means is controlled such to give the interface and thus flexible means a defined form, where the flexible means is solidified in this condition, thus forming the optical medium, where at least one further fluid can be poured into the fluid cells of the structure, where the fluid cells of the structure are sealed and where the optical component according to claim 1 can thus be made.

31. Method according to claim 29, where the definable shape of the flexible means has a substantially planar surface which faces an adjacently arranged fluid or where the flexible means comprises different shapes or orientations in individual fluid cells or where the solidification of the flexible means is realised with the help of a photochemical reaction or a catalytic curing reaction.

32-33. (canceled)

34. Method according to claim 30, where the definable shape of the flexible means has a substantially planar surface which faces an adjacently arranged fluid or where the flexible means comprises different shapes or orientations in individual fluid cells or where the solidification of the flexible means is realised with the help of a photochemical reaction or a catalytic curing reaction.
